(19) United States
(12) Patent Application Publication
(10) Pub. No.: US 2016/0135391 A1
(43) Pub. Date: May 19, 2016

(54) PLANT WATER RESERVOIR

(71) Applicants: Dave Fenton, Temecula, CA (US); Lori Fenton, Temecula, CA (US)

(72) Inventors: Dave Fenton, Temecula, CA (US); Lori Fenton, Temecula, CA (US)

(21) Appl. No.: 14/541,575

(22) Filed: Nov. 14, 2014

(51) Int. Cl. A01G 27/04

(52) U.S. Cl. CPC A01G 27/04

(57) ABSTRACT

A plant watering reservoir has a container having a container sidewall. Sidewall openings are formed on the container sidewall. The sidewall openings are large enough to allow passage of water. A cavity section is formed within the container. The cavity section includes an air cavity having air and superabsorbent polymer hydrogel loaded into the cavity section. A solid vertical column is formed between columns of vertical sidewall openings. A solid horizontal column is formed between rows of horizontal sidewall opening. The superabsorbent polymer hydrogel is loaded to a loading amount of less than full volume when the superabsorbent polymer hydrogel fully engorged.

### FIELD OF THE INVENTION

The present invention is in the field of plant water reservoirs.

### DISCUSSION OF RELATED ART

The idea of an underground irrigation system is discussed in the prior art. U.S. Pat. No. 8,677,687 was issued Mar. 25, 2014 to inventor George Pierce Nottingham entitled Method of Producing an Agricultural Polymer Protected Root Ball, the disclosure of which is incorporated herein by reference. The Nottingham patent describes a root ball with soil and a layer of agricultural polymer that creates a semi-permeable outer layer for protection of the roots. In U.S. Pat. No. 6,453,607 issued Sep. 24, 2002 to inventor Jon R. Dewey entitled Root-Level Plant Watering and Feeding Device, the disclosure of which is incorporated herein by reference, Dewey describes a root-level plant watering system with a tube extended to the surface. A similar design with a novel function can be seen in U.S. Pat. No. 4,038,780 issued Aug. 2, 1977 to inventor Edward C. Bruno entitled Water Container Device for Plants, which is a means for supplying water for indoor plants for prolong periods of time. Another related invention is U.S. Pat. No. 689,248, issued Dec. 17, 1901 to inventor Rudolf Timm entitled Apparatus for Automatically Moistening Substances. The Timm patent is a device with different shaped orifices attached to a pipe that is used to keep granular, pulverulent, or porous substances constantly wet with liquid. The pipe is inserted in the soil and will only release liquid upon insertion into the soil.

A variety of different water storage devices improves plant growth. U.S. Pat. No. 2,837,869 issued to inventor Chatten Victor H on Jun. 10, 1958 is entitled Plant-Watering Device and describes a device used for moistening soil by supplying a plant with the necessary amount of water. The Victor H patent is composed of a porous ceramic bulb and stem. The stem is below the surface of the soil and the bulb stays above the surface.

U.S. Pat. No. 3,109,258 is entitled Root Watering Device issued to Merlin R. Jensen on Nov. 5, 1936, the disclosure of which is incorporated herein by reference. The Jensen patent is a root watering device that is partially submerged into the soil and partially extended above the surface; the supply conduit extends above the surface and is attached to the annular ring below the surface. The annular ring has perforations used to water the roots. The device retains a ball of earth around the roots.

Another related irrigation device is U.S. Pat. No. 5,761,846 issued Jun. 9, 1998 to inventor Richard F. Marz, entitled Underground Irrigation Device. The Marz patent is an underground irrigation device with several through-holes around its perimeter that allow for the diffusion of pesticides and fertilizers into the soil; an extension to the device extends out of the soil and can be attached to a hose.

U.S. Pat. No. 7,441,369 issued Oct. 28, 2008 to inventor Mcatee Joseph P, entitled Device for Efficiently Dispensing Fertilizer and Other Chemical to the Roots of a plant, describes an apparatus of a feeder tube with an open bottom and top end that is perforated along the tubular body that is buried into the ground and used to dispense a selected compound to the roots of a particular plant.

U.S. Pat. No. 588,278 issued on Aug. 17, 1897 to inventor Herman Kling entitled Tree-Irrigator is another irrigating device that is inserted into the ground, with an irrigating tube that has perforations provided to allow for the escape of contents to tree roots and the like.

In U.S. Pat. No. 5,016,548 issued May 21, 1991 to inventor Yoshihide Ito entitled Method of Planting Seedling describes an apparatus with a long tube-like body inserted into the ground that is open at the top end and perforated at the lower end that provides water to seedlings and allows for their breeding. Another watering device is U.S. Pat. No. 6,540,436 issued on Apr. 1, 2003 to inventor Jeffrey M. Ogi, the disclosure of which is incorporated herein by reference. The Ogi patent is a deep root watering unit for the purpose of improved irrigation and aeration of tree roots and the like that is composed of a porous sleeve that is attached to an atrium housing designed for different types of irrigation water dispensing devices; the device is inserted below the ground.

A National Patent WO2004/107850 A1 entitled Tree Watering issued on Dec. 16, 2004 to Ensbey Andrew describes a device that allows for the care and watering of a tree by storing storm water. The Andrew patent consists of a root ball and a perforated distributor that surrounds the root ball. The distributor is attached to a sump that has an open top to allow for water flowing over a kerbstone to be collected and distributed to the roots of the tree.

Some designs are used to store water and not to distribute water. They have a similar structure to the patents listed above even though they do not function the same. Other inventions regarding water storage includes U.S. Pat. No. 2,387,598 issued Oct. 23, 1945 to inventor Mercier Jean entitled Oleopneumatic Storage Device. The Jean patent describes a spherical metallic container with an elastic bag inside that is used for the storage of liquid. The liquid can be admitted or withdrawn through one end of the container. Chinese Patent 203,559,609U issued on Apr. 20, 2014 entitled Mould for Building Spherical and Cylindrical Water Cellar and Cellar describes an apparatus of a ball shaped underground cistern. Another invention regarding water storage devices is U.S. Pat. No. 4,300,634A1 entitled Demountable Rainwater Storage Tank issued to Juergen Bender on Jul. 14, 1994. The Bender patent consists of a spherical underground water storage device that utilizes rain water and consists of an opening that reaches above the ground.

U.S. Pat. No. 8,829,107 issued to inventors Franck Furmo, Harald Schidmt, and Nicolaas De Bruin on Sep. 9, 2014 is entitled Biodegradable Superabsorbent Polymer Composition with Good Absorption and Retention Properties, the disclosure of which is incorporated herein by reference. The Furmo et al. patent describe a method of production of a superabsorbent composition. This composition is created through the method of a particulate superabsorbent composition plus a composite, with the incorporation of a starch compound.

Another related method of composition related to this particular invention is patent number 2,009,022,358 issued to inventors Luigi Ambrosio, Luigi Nicolais, and Alessandro Sannino on Feb. 19, 2009 entitled Superabsorbent Polymer Hydro Gels and a Method of preparing Thereof. The Ambrosio et al. patent is a superabsorbent hydrogel classified by its biocompatibility of high water content and fluctuating absorption rate based on stimuli. This superabsorbent polymer can also be obtained using a compound of starch and cellulose derivatives mentioned in U.S. Pat. No. 6,070,337 issued to the previously mentioned inventors on Jul. 6, 2006.

U.S. Pat. No. 7,059,273 issued on Jun. 13, 2006 to inventors Vincent Y. Wong, Leonard E. Small, Alice M. Ward, and Richard J. Sackenheim is entitled Absorbent Composition and Extended Use Pet Litter, the disclosure of which is incorporated herein by reference. The Wong et al. patent describe an absorbent composition of a wide range of absorbent particles such as pre-gel starch or anti fungal agents, those of which are a high capacity absorption material that can absorb liquids at least two to five times its initial weight.

U.S. Pat. No. 7,607,259 entitled Superabsorbent Polymer Root Dip to inventor Savich issued Oct. 27, 2009 is a method of delivering super absorbent polymer to a plant. The polymer hydrogel is comprised of a starched and potassium salt starch graft copolymer composition. United States publication 2007116400 also describes a tablet for absorbing waste drainage.

### SUMMARY OF THE INVENTION

A plant watering reservoir has a container having a container sidewall. Sidewall openings are formed on the container sidewall. The sidewall openings are large enough to allow passage of water. A cavity section is formed within the container. The cavity section includes an air cavity having air and superabsorbent polymer hydrogel loaded into the cavity section. A solid vertical column is formed between columns of vertical sidewall openings. A solid horizontal column is formed between rows of horizontal sidewall opening. The superabsorbent polymer hydrogel is loaded to a loading amount of less than full volume when the superabsorbent polymer hydrogel fully engorged.

Optionally, the plant watering reservoir container is spherical shaped. The container can have an upper hemispherical section bonded to a lower hemispherical section. The sidewall openings can be round. The sidewall openings can be rectangular. A receiving line has a receiving line top opening and a receiving line lower opening. A container top opening is formed on the top surface of the container. The receiving line lower opening connects to the container top opening.

### BRIEF DESCRIPTION OF THE DRAWINGS

FIG. 1 is a side view of the plant water reservoir.

FIG. 2 is a perspective view of the plant water reservoir.

FIG. 3 is a cross section view of the plant water reservoir showing dried superabsorbent polymer hydrogels.

FIG. 4 is a cross-sectional view of the plant water reservoir showing engorged superabsorbent polymer hydrogels.

FIG. 5 is a side view of the plant water reservoir.

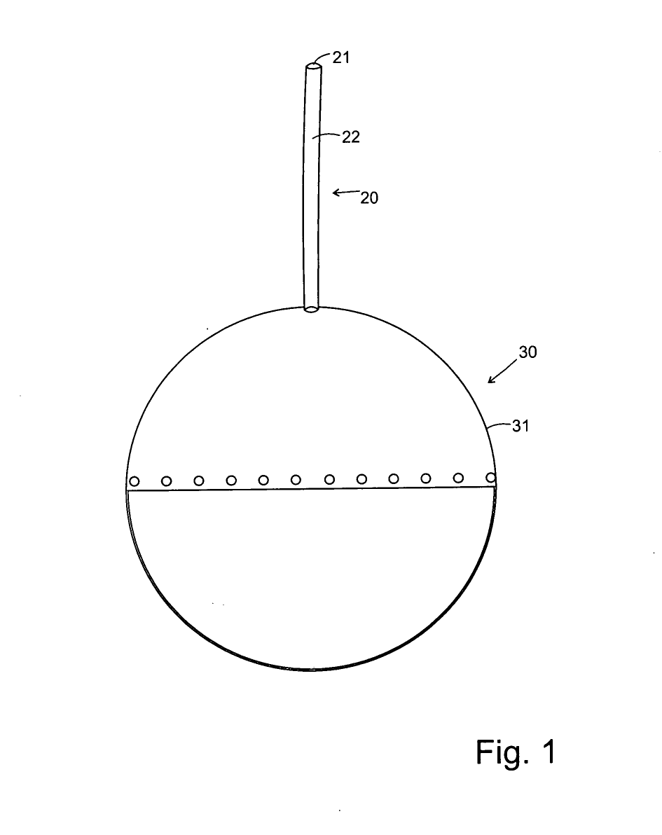

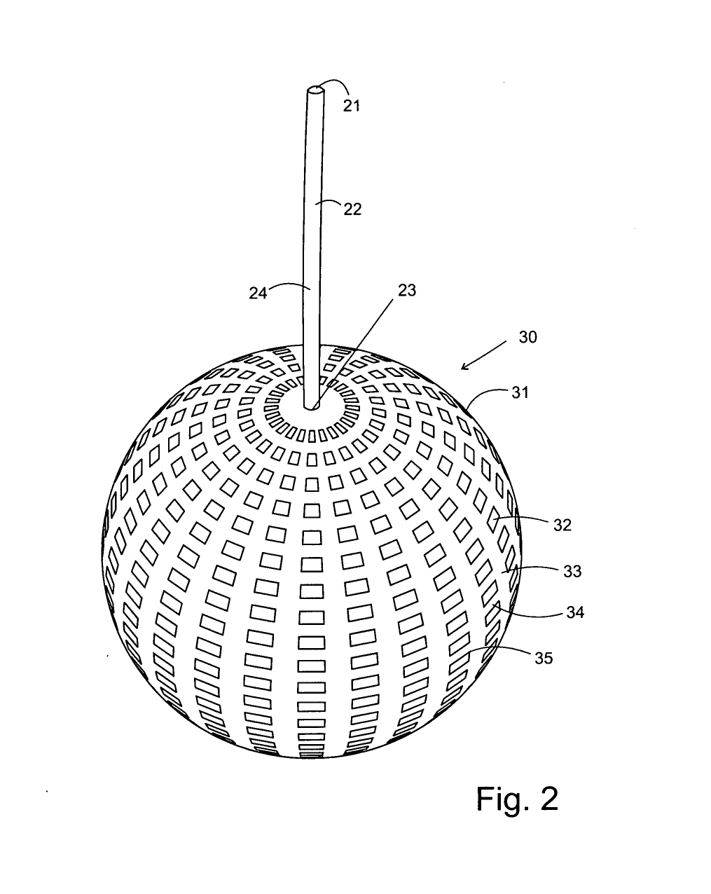

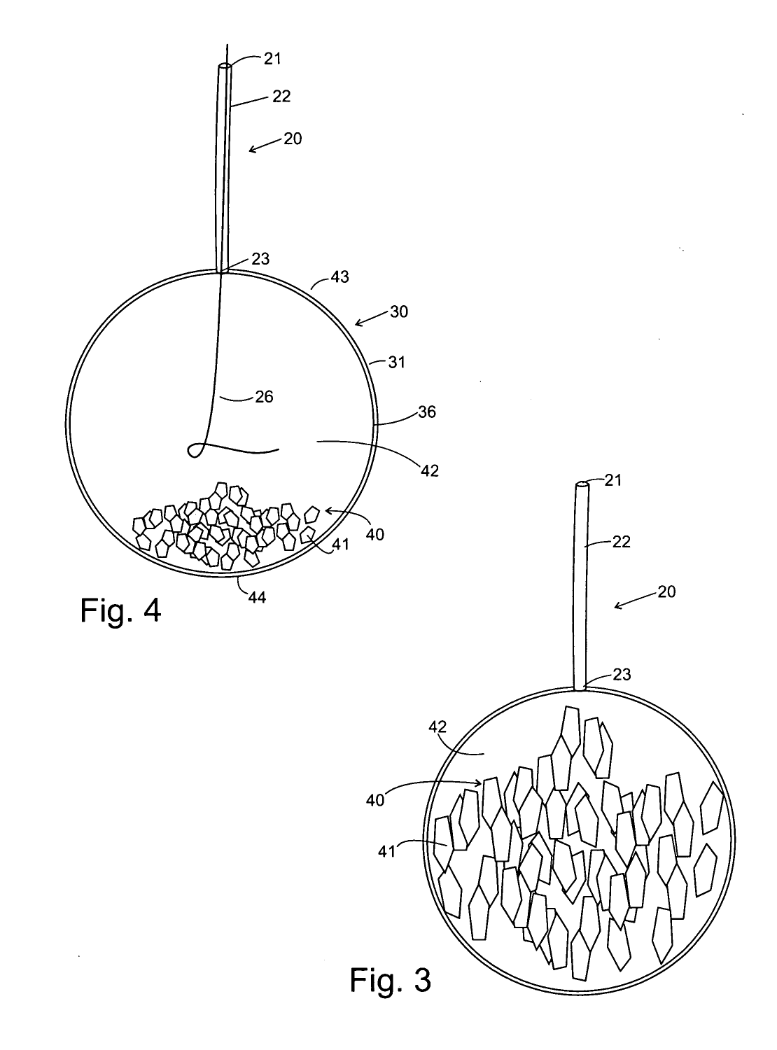

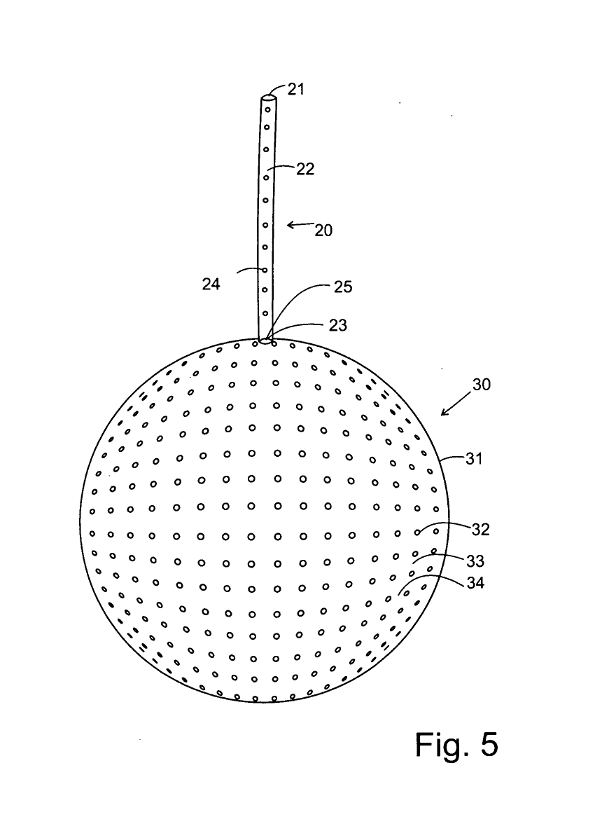

The following call out list of elements is a useful guide in referencing the elements of the drawings.
20 Receiving Line
21 Receiving Line Top Opening
22 Receiving Line Sidewall
23 Container Top Opening
24 Receiving Line Sidewall Opening
25 Receiving Line Lower Opening
30 Container
31 Container Sidewall
32 Sidewall Opening
33 Vertical Column
34 Horizontal Column
35 Sidewall Opening Corner
36 Bonding Line
40 Interior Cavity
41 Superabsorbent Polymer Hydrogel
42 Air Cavity
43 Upper Hemispherical Section
44 Lower Hemispherical Section

### DETAILED DESCRIPTION OF THE PREFERRED EMBODIMENT

The present invention simultaneously provides aeration and superabsorbent polymer hydrogel hydration while avoiding evaporation water loss. The device is buried in a plant pot or in the ground with the receiving line reaching the surface, or almost to the surface. Optionally, the device can be used without the receiving line when the container top portion is close to the surface or above the surface. The relatively small size of the device allows the user to separate polymer hydrogel from soil once installed.

Superabsorbent polymer hydrogels are encapsulated within a container having side openings. A wide variety of different absorbent materials or superabsorbent polymer hydrogels can be used, such as sodium polyacrylate, starch based compounds, nano composite hydrogels or the like. The container optionally includes a top opening leading to a feeder line. The feeder line can be connected to the top opening.

The openings can be rectangular or circular. Circular openings can be 1 mm diameter holes arranged on the external surface of the container. The feeder line can be formed as a straight tube having ⅜″ outside diameter with a quarter inch inner diameter. The container can be made as a sphere of 4 inch diameter. The superabsorbent polymer hydrogels crystals can be loaded into the container before sealing the container.

The feeder line can be formed as a receiving line 20 with a receiving line top opening 21 and a receiving line lower opening 25. The receiving line lower opening 25 connects with the receiving line top opening 21 so that water can flow from the receiving line top opening 21 to the receiving line lower opening 25. The receiving line sidewall 22 of the receiving line 20 is generally solid but may have a plurality of receiving line sidewall openings 24 along a length of the receiving line 20. The receiving line 20 feeds water to the container 30 through the container top opening 23. The feeder line also allows sub irrigation if a wick 26 is optionally included in the feeder line. The wick 26 can receive water by capillary action through the receiving line top opening 21. The wick 26 can be mounted to the receiving line top opening 21 such that it protrudes from the receiving line top opening 21. The wick 26 can be made of a string optionally including a knot for retaining the string.

The container 30 can be formed with a container sidewall 31. The container sidewall 31 can be of a spherical shape, or other shapes. The container sidewall 31 can be made of a plastic injection molded ball having an upper hemispherical section 43 and a lower hemispherical section 44 that are connected together at a bonding line 36 along an equatorial circumperiphery such as by means of sonic welding, a screwed connection, snap together mechanical construction or adhesives. The container sidewall can have rows of sidewall openings with a solid horizontal column between the rows of sidewall openings. Similarly, the container sidewall can have columns of sidewall openings with solid vertical columns between the columns of sidewall openings. The solid vertical columns and solid horizontal rows are regions where there are no openings. The openings can be rectangular or circular, or other shapes. When made rectangular, the openings can have a sidewall opening corner 35, optionally beveled to promote root redirection.

The upper hemispherical section and the lower hemispherical section joined together to form a cavity 40. The cavity 40 has an air cavity 42 and is at least partially filled with absorbent material such as superabsorbent polymer hydrogel 41. The absorbent material engorges when absorbing water to fill the air cavity 42. The superabsorbent polymer hydrogel 41 can be made of a nano composite hydrogel. Optionally, the superabsorbent polymer hydrogel 41 can be put in a mesh bag before being placed inside the inside cavity. The superabsorbent polymer hydrogel is loaded to a loading amount of less than full volume when the superabsorbent polymer hydrogel fully engorged.

The orientation of the openings in the sidewall can be in a row along the upper hemispherical section. Preferably, twenty four one millimeter openings are formed on the upper hemispherical section. The lower hemispherical section can be solid for retaining water, or can have openings.

1. A plant watering reservoir comprising:
a. a container having a container sidewall;
b. sidewall openings formed on the container sidewall, wherein the sidewall openings are large enough to allow passage of water; and
c. a cavity section formed within the container, wherein the cavity section includes an air cavity having air and superabsorbent polymer hydrogel loaded into the cavity section.

2. The plant watering reservoir of claim 1, further comprising:
a. a solid vertical column formed between columns of vertical sidewall openings; and
b. a solid horizontal column formed between rows of horizontal sidewall opening.

3. The plant watering reservoir of claim 1, wherein the superabsorbent polymer hydrogel is loaded to a loading amount of less than full volume when the superabsorbent polymer hydrogel fully engorged.

4. The plant watering reservoir of claim 1, wherein the container is spherical shaped.

5. The plant watering reservoir of claim 1, wherein the container has an upper hemispherical section bonded to a lower hemispherical section.

6. The plant watering reservoir of claim 1, wherein the sidewall openings are round.

7. The plant watering reservoir of claim 1, wherein the sidewall openings are rectangular.

8. The plant watering reservoir of claim 1, further comprising:
a. a receiving line having a receiving line top opening and a receiving line lower opening; and
b. a container top opening formed on the top surface of the container, wherein the receiving line lower opening connects to the container top opening.

9. The plant watering reservoir of claim 8, further comprising:
a. a solid vertical column formed between columns of vertical sidewall openings; and;
b. a solid horizontal column formed between rows of horizontal sidewall opening.

10. The plant watering reservoir of claim 8, wherein the superabsorbent polymer hydrogel is loaded to a loading amount of less than full volume when the superabsorbent polymer hydrogel fully engorged.

11. The plant watering reservoir of claim 8, wherein the container is spherical shaped.

12. The plant watering reservoir of claim 8, wherein the container has an upper hemispherical section bonded to a lower hemispherical section.

13. The plant watering reservoir of claim 8, wherein the sidewall openings are round.

14. The plant watering reservoir of claim 8, wherein the sidewall openings are rectangular.
